(19) United States
(12) Patent Application Publication
(10) Pub. No.: US 2009/0132283 A1
(43) Pub. Date: May 21, 2009

(54) Dental treatment support system and X-ray sensor for the same

(75) Inventors: Hitoshi HARA, Tokyo (JP); Koji ASANO, Ishikawa (JP)

Correspondence Address: NIXON & VANDERHYE, PC, 901 NORTH GLEBE ROAD, 11TH FLOOR, ARLINGTON, VA, 22203, US

(73) Assignee: ASANO DENTAL INCORPORATED, Kanazawa-shi (JP)

(21) Appl. No.: 12/153,759

(22) Filed: May 23, 2008

(30) Foreign Application Priority Data
Nov. 20, 2007 (JP) 2007-300589

(51) Int. Cl. G06Q 50/00; H05G 1/64

(52) U.S. Cl. 705/3; 378/98

(57) ABSTRACT

The objective of the present invention is provision of a dental treatment support system and X-ray sensor for the same, which enable a user to take X-ray photograph available to the diagnostic, the treatment, and the like in dental facilities easily. The support system comprises: a dental clinic side terminals 11, 12, DS servers 21, 22, and highly advanced hospital side clients 31, 32, which are communicatively connected over networks 5˜7. The terminals 11, 12 are capable of transmitting medical information including: a partially enlarged X-ray image of a part of teeth and/or a panorama X-ray image of teeth, request information for requesting advice on the diagnosis and/or treatment of a patient, and information designating output extent. The servers 21, 22 are capable of receiving the medical information from the terminals 11, 12, storing the information and transmitting to an authenticated accessor. The clients 31, 32 are capable of receiving the medical information within the extent designated by the output extent from the server 21, 22 after being authenticated, and transmitting medical advice information. The server 21, 22 is further capable of storing and transmitting the medical advice information returned from the client 31, 32 to the terminal 11, 12 which requires it.

### BACKGROUND OF THE INVENTION

The present invention relates to a dental treatment support system and X-ray sensor for the same enabling preparation and/or transmission of X-ray photograph used for the diagnosis and the treatment in the dental field.

Conventionally, there is a certain limitation for performing in a general clinic a dental operation necessitating higher dental technique, such as dental implantation. For example, in order to perform such a treatment, it is necessary to have close and frequent communication with such as a university hospital which has doctors with higher skill in the field of diagnosis using image, such as X-ray transmission image. Thereby benefits of the treatment are not always obtainable in a general clinic, a general hospital, and the like.

In the mean while, since in the medical and/or dental fields, the Highly Advanced Healthcare Project (refer to the Non-patent document 1.) is promoted recently, medical staffs with higher medical technique are gathered in such a university hospital, a core hospital, and the like. In order to have such a highly advanced healthcare, a patient forced to get a letter of introduction, go to the corresponding hospital even if it is far from his/her home, or do another tiresome things. Therefore, it is officially investigating to apply the higher medical technique belonging to such as a university hospital to the other medical clinic, hospital, and so on.

[Patent document 1] WO/2003/039372

[Non-patent document 1] Internet <URL: http://www.enjoy.ne.jp/˜h.simizu/koudo.html>

[Non-patent document 2] Internet <URL: http://www.schicktech.com/items.php?catid=493>

[Non-patent document 3] Internet <URL: http://www.schicktech.com/items.hp?catid=565>

However, regarding the conventional dental healthcare support system, there are problems that it is not easy to take X-ray transmission image available for such as the diagnostic, the treatment, and the like, to obtain the X-ray transmission image by transmitting the data between the corresponding medical facilities with high security, and so on.

Considering the state of the present art, the objective of the present invention is provision of a dental treatment support system and X-ray sensor for the same, which enable a user to take X-ray photograph available to the diagnostic, the treatment, and the like in dental facilities easily.

### SUMMARY OF THE INVENTION

The aforementioned objective is achieved by the following configurations.

(1) According to the claim 1, there is provided a dental treatment support system comprising: a dental clinic side terminal, a data security server, and a highly advanced hospital side client, which are communicatively connected with each other over network; wherein said dental clinic side terminal is capable of transmitting medical information including: a partially enlarged X-ray image of a part of teeth and/or a panorama X-ray image of teeth, request information for requesting advice on the diagnosis and/or treatment of a patient, and information designating output extent; said data security server is capable of receiving said medical information from said data security server, storing the information and transmitting to an authenticated terminal; and said highly advanced hospital side client is capable of receiving said medical information within the extent designated by the output extent from said data security server after being authenticated, and transmitting medical advice information; and wherein said data security server is capable of storing and transmitting the medical advice information returned from said authenticated highly advanced hospital side client to said dental clinic side terminal which require it.

(2) According to the claim 2, there is provided a dental treatment support system of claim 1, wherein said medical advice information includes medical advice from a doctor on the periodontitis.

(3) According to the claim 3, there is provided an X-ray sensor for capturing the partially enlarged X-ray image of claim 1, said sensor comprising: an X-ray light conversion member having a size capable of being put in a mouth cavity and converting the incident X-ray flux into visible light; a CCD operable to detect both the intensity of the converted light and corresponding re-emitting position; a non-volatile memory for receiving the both data output from said CCD and storing the intensity of the light and the corresponding re-emitting position in pairs; and a wireless communication means operable to work responding to a wireless communication event and capable of outputting the original image stored in the non-volatile memory.

According to the invention of claim 1, since the dental treatment support system has an aforementioned configuration, it is possible to provide with a dental treatment support system which enables a user to take X-ray photograph available to the diagnostic, the treatment, and the like in dental facilities easily.

According to the invention of claim 2, since the medical advice information includes medical advice from a doctor on the periodontitis, there is provided with an advantage that a dentist can easily obtain medical advice on periodontitis, in addition to the aforementioned advantage of claim 1.

According to the invention of claim 3, since the X-ray sensor has an aforementioned configuration, it is possible to provide with an X-ray sensor which enables a user to take X-ray photograph available to the diagnostic, the treatment, and the like in dental facilities easily.

### BRIEF DESCRIPTION OF THE DRAWINGS

FIG. 1 is a block diagram schematically illustrating an exemplary configuration of a dental support system according to the present invention.

FIG. 2 is a view showing the exemplary transmission X-ray image sent to the data security server.

FIG. 3 is a schematic view illustrating an exemplary system for the X-ray measurement capable of capturing the partially enlarged X-ray image.

FIG. 4 is a view illustrating the appearance and the configuration of the X-ray sensor for dental support; (a) is a schematic view illustrating the cross-section of a part for detecting X-ray and a circuit connected to it; (b) is an overall perspective view.

### DETAILED DESCRIPTION OF THE PREFERRED EMBODIMENTS

Hereinafter, embodiments according to the present invention are described referring to figures showing the examples.

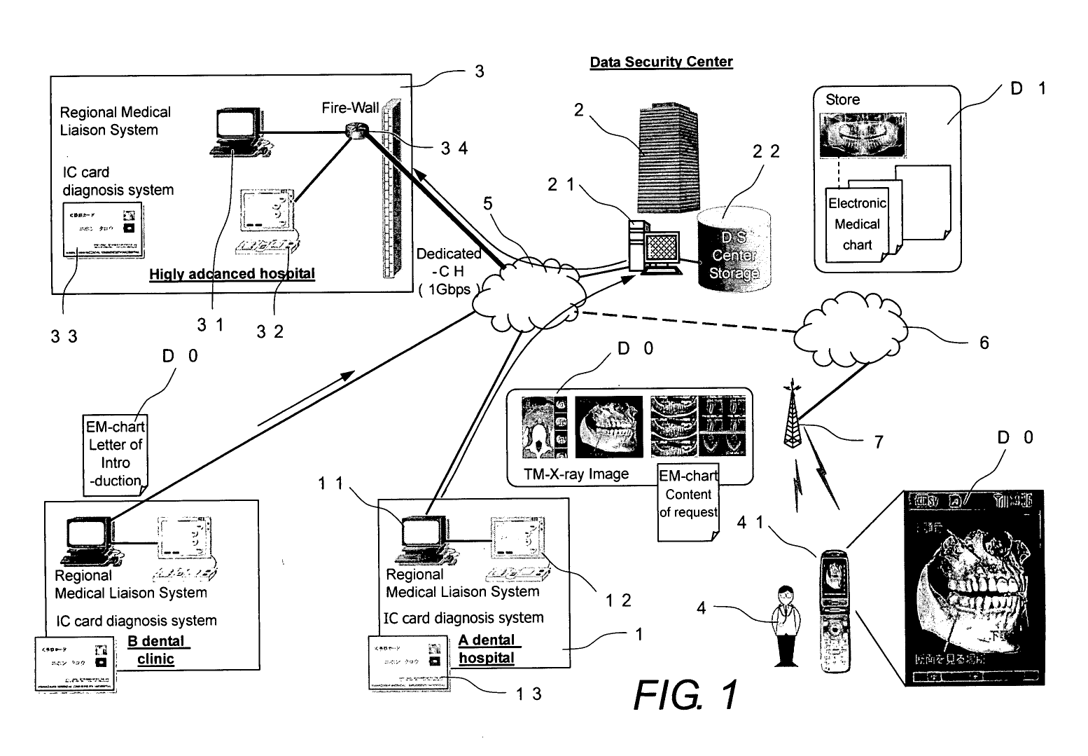

FIG. 1 is a block diagram schematically illustrating an exemplary configuration of a dental support system according to the present invention. The dental support system comprises as shown in FIG. 1: computer terminals 11, 12 installed in a dental clinic 1; a data security server (hereinafter, referred to as “DS server.”) 21 and a storage apparatus 22 installed in a data security center (hereinafter, referred to as “DS center.”) 2; and computer terminals 31, 32, 34 installed in a highly advanced hospital 3.

Hereat, the dental clinic 1 represents a clinic (shown in FIG. 1 as “A dental hospital” or “B dental clinic.”) locating at various place and where a general practitioner sees a patient. The dental clinic 1 is also a clinic other than the highly advanced hospital 3, except for the deference of the name such as dental hospital, dental clinic, and the like. The highly advanced hospital 3 represents a medical facility such as university hospital, core hospital, designated medical facility, and the like, which has higher medical technology or highly advanced medical technology (hereinafter, simply referred to as “highly advanced medical technology.”).

The dental clinic side terminal 11 installed in the dental clinic 1 is communicatively connected to the network 5; and the dental clinic side client 12 is the client of the dental clinic side terminal 11 and communicatively connected to the network 5 via the terminal 11. In addition, an IC card reader is communicatively connected to the dental clinic side terminal 11 and/or the dental clinic side client 12 (hereinafter, simply referred to as “terminal 11, 12.”); and thereby information for the medical examination (hereinafter, referred to as “patient's registration information.”) can be read from a patient's registration IC card 13 by means of an IC card reader. Patient's registration information is stored in the terminal 11, 12 at the preparation of the IC card 13 and is used for certification of the patient, the identification of the management number of his/her healthcare insurance, and the like.

The dental clinic 1 is also possible to be provided with a diagnostic image preparation apparatus such as the scanning X-ray image camera (refer, for example, to the Patent Document 1.) capable of capturing panorama image (hereinafter, referred to as “panorama X-ray image.”) of a tooth/teeth, through which X-ray transmits, the partial X-ray photograph camera (for example, refer to the Non-patent Document 2.) capable of capturing an enlarged X-ray image of a diseased/abnormal part(s) of a tooth/teeth or its/their vicinity (hereinafter, referred to as “partially enlarged X-ray image.”), and so on. By way of being available a diagnostic image(s) such as the panorama X-ray image, the partially enlarged X-ray image, it becomes easy to perform the explanation on the dental implantation, orthodontics, and thereby practical use of the highly advanced medical technology is further promoted. Here, regarding the transmission X-ray image, it is also possible to use the on/those captured in the other medical facility.

By means of terminal 11, 12, contents of diagnosis and/or treatment and another related information are written in an electronic medical chart; and if there is/are related X-ray image, it/they is/are stored together with the electronic medical chart. These information such as the electronic medical chart, the transmission X-ray image, and so on may, for example, be sent to the DS server 21 and so on, and then be stored to each dental clinic 1, with high security obtainable by using such as an encryption technique, etc.

In this configuration, the medical information is managed so as to be sent to an external apparatus after authentification by the DS server 21. A password is available for the authentification, for an example. Further, an output extent for defining the medical data stored in the DS server 21 licensed to be output to the external apparatus, may be preset as a part of the medical information in the terminal 11, 12.

As the output extent, it is possible to assign the entire medical information received from the terminal 11, 12 to itself/themselves and the extent designated by way of the terminal 11, 12, the sender(s), to the terminals 31, 32, 34 of the highly advanced hospital 3 to which advice was requested, respectively. Here, the request for advice from the dental clinic 1 to the highly advanced hospital 3 is performed by means of e-mail, telephone, and the like.

To the DS server 21 installed in the DS center 2, the DS center storage apparatus 22 is communicatively connected; and the DS server 21 stores the received data to the DS center storage apparatus 22 after performing the process, such as encryption, which increases security against the data leakage. In the DS center storage apparatus 22, following medical information D10 is/are stored: the information sent from each dental clinic side terminal 11, another information sent from any one of the terminals 31, 32, 34 of the highly advanced hospital 3 (hereinafter, referred to as “medical advice information.”), and the like. The former information sent from the terminal 11 includes such as the panorama X-ray image, the partially enlarged X-ray image, the information on the request, a letter of introduction, and so on.

Hereat, the information on the request includes, for example, such as articles requesting advice, information on the patient (such as allergy), and another information regarding the request. Further the medical advice information includes, for example, a report on the diagnosis and the treatment regarding the articles requested by the dental clinic 1 as well as image supplementary to them, e-mail, and the like. Moreover, the letter of introduction represents the one popularly used between medical facilities. Among the returned information, it is possible to store the respective updated information in a file so as to be distinguishable from the other, where the file(s) contain(s) the medical advice information. For example, updated information including such as the information on the advice, the transmission X-ray image updated by marking, is distinguishably stored in a file, respectively.

The DS server 21, when being accessed, performs the authentification by using for example password; and if the access is authenticated, the DS server 21 decodes target encrypted medical information such as the electronic medical chart, and returns the information within the extent defined by the output extent.

Inside the highly advanced hospital 3, a plurality of terminals 31, 32, each of which works as the client, (hereinafter, referred to as “highly advanced hospital side client.”), are communicatively connected each other via the terminal 34, where the terminal 34 works as a firewall and is linked to the network 5 (hereinafter, referred to as “firewall server.”).

After the advice was requested from the dental hospital 1 and the medical information was registered to the DS center storage apparatus 22, the highly advanced hospital side clients 31, 32 are capable of, for example, receiving the target medical information such as the electronic medical chart, the transmission X-ray image, and so on, by way of accessing to access the DS server 21. Thereby the corresponding medical specialist 4 is capable of browsing the received medical information inside the highly advanced hospital 3.

Besides, each medical specialist 4 belonging to the highly advanced hospital 3 has a mobile communication terminal 41, and their contact information such as telephone numbers of the mobile communication terminal 41, email addresses and the like are managed by the highly advanced hospital side clients 31, 32. Further, the received medical information is capable of being sent partially or entirely to a telephone number(s), an email address(es) and the like stored in the highly advanced hospital side clients 31, 32. Thereby the medical specialist 4 is capable of browsing data in the visiting place and the doctor, the request person, of the dental hospital 1 is capable of obtaining necessary information within a relatively short time. Here, the medical advice information regarding such as diagnosis, treatment and the like prepared by the medical specialist 4 of the highly advanced hospital 3 are returned to the DS server 21 of the DS center 2, stored so as to be accompanied with the corresponding electronic medical chart, and managed. Further, it is also possible that the highly advanced hospital side clients 31, 32 returns the medical advice information containing the output extent to the DS server 21 and the terminal 11, 12 receive(s) the medical advice information after being authenticated by the DS server 21. Here, the medical advice information may include advice on the periodontitis, for example, information on the improvement of habits.

Here, the network 5 comprises a higher security network(s), for example, capable of providing with higher security channels within the channels used in the public communication service network, and the network 5 has a communication bandwidth(s) of, for example, 1 Gbps or more. Further the mobile communication terminal 41 is capable of the communication over the network 6 (via a base station tower 7) for usual mobile phones.

In FIG. 1, the medical information D01 comprising, for example, the electronic medical chart, the X-ray transmission image, the information on the request, and the like, is sent from the dental clinic side client 12 to the DS server 21 and then stored in the DS center storage apparatus 22. The stored medical information D01 is partially or entirely sent responding to the access of the highly advance hospital side clients 31, 32 via the firewall server 34 after being authentificated. In the exemplary case shown in FIG. 1, owing to the absence of the medical specialist 4, the medical information D01 received by the highly advance hospital side clients 31, 32 is partially or entirely sent to the destiny mobile communication terminal 41 by means of e-mail attached with it D01 and then displayed on a screen of the mobile communication terminal 41.

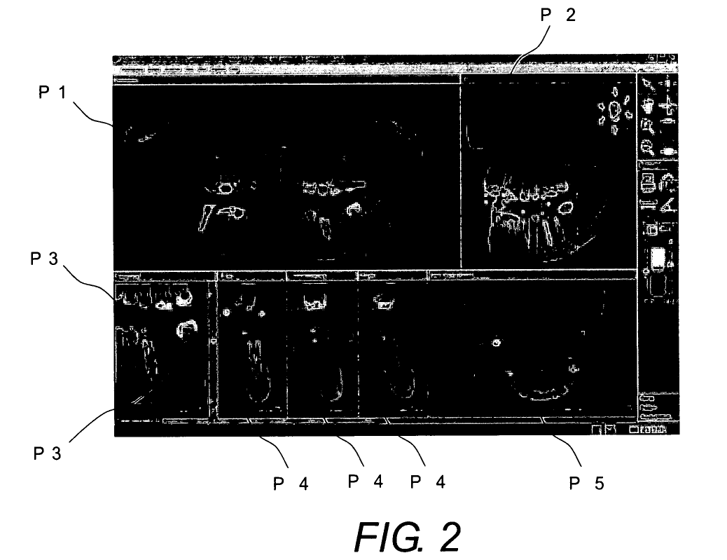

FIG. 2 is a view showing the exemplary transmission X-ray image sent to the data security server. FIG. 2 exemplary illustrates, such as, diagnosis for the dental implantation, the transmission X-ray image sent when requesting the advice on the treatment, and so on. In FIG. 2, image P10 in the upper left-hand side is the panorama transmission X-ray image; image P20 in the upper right-hand side is the transmission X-ray image of the diseased part taken from the side, where the image P20 corresponds to the image P10. Further, Images P30, P41˜P43 shown in FIG. 2 are the partially enlarged X-ray image of the diseased part or of its vicinity. Moreover, the image P50 shown in FIG. 2 illustrates the configuration for capturing the partially enlarged X-ray image. The diseased part to be treated using the dental implantation technique is shown as an area P31 in the image P30.

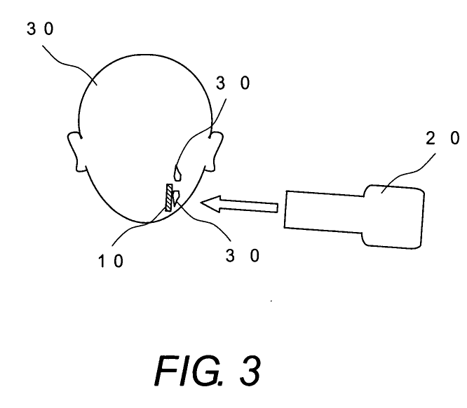

FIG. 3 is a schematic view illustrating an exemplary system for the X-ray measurement capable of capturing the partially enlarged X-ray image. In FIG. 3, an X-ray sensor for so-called “dental support” 100, which detects X-ray radiated from a generator of X-ray (hereinafter, referred to as “X-ray source”) 200, is positioned along the diseased part or its periphery of the teeth 301 of the patient 300. Hereat, the symbol 301 indicates the lower jaw and the symbol 302 indicates the upper jaw.

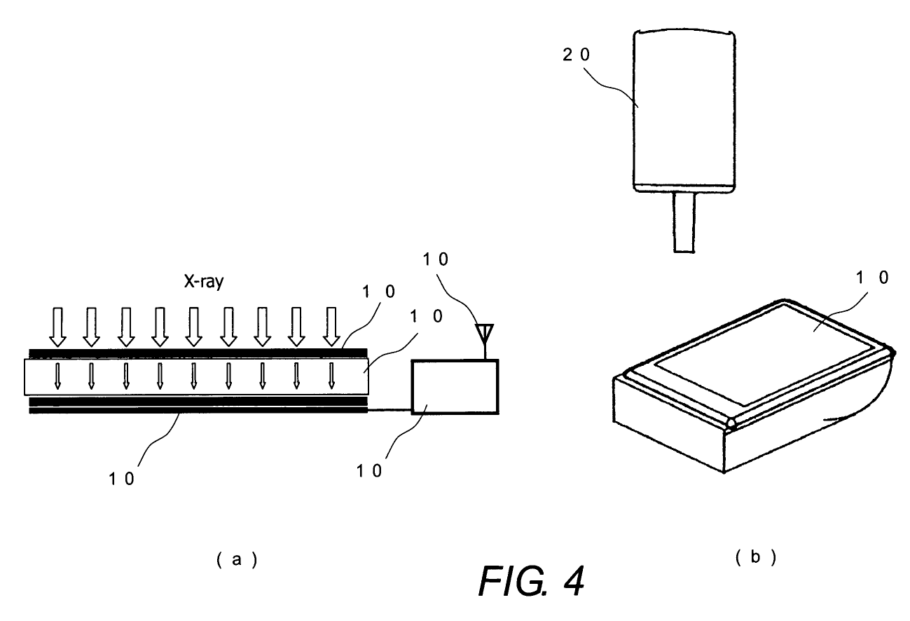

FIG. 4 is a view illustrating the appearance and the configuration of the X-ray sensor for dental support; (a) is a schematic view illustrating the cross-section of a part for detecting X-ray and a circuit connected to it; (b) is an overall perspective view. The X-ray sensor for dental support 100 comprises: an X-ray light conversion member 101 having such as photoluminescence material which converts incident X-ray flux to visible light; a CCD (Charge Coupled Device) 103 for receiving the light re-emitted by the X-ray light conversion member 101; a light propagating media 102 which is positioned therebetween, protects the CCD103 and propagates the light re-emitted from the X-ray light conversion member 101; a memory 104 for being input signal representing the transmission X-ray image from the CCD 103 and thereby non-volatilely storing the image; and a wireless communication means 105 for working responding to an external wireless access and outputting the transmission X-ray image stored in the memory 104 to the reader-writer accessing it.

The X-ray sensor for dental support 100 is, as shown in FIG. 4 in detail, aligned so as that the X-ray radiated from the X-ray source 200 enters normal to it. Hereat, the memory 104 is configured to be driven by a battery not shown, receives the transmission X-ray image signal, and memorizes it. Further, the wireless communication means 105 may be driven by the aforementioned battery, or by electromagnetic energy supplied by the reader-writer as usual.

What is claimed is:

1. A dental treatment support system comprising: a dental clinic side terminal, a data security server, and a highly advanced hospital side client, which are communicatively connected with each other over network; wherein
said dental clinic side terminal is capable of transmitting medical information including: a partially enlarged X-ray image of a part of teeth and/or a panorama X-ray image of teeth, request information for requesting advice on the diagnosis and/or treatment of a patient, and information designating output extent;
said data security server is capable of receiving said medical information from said dental clinic side terminal, storing the information and transmitting to an authenticated accessor; and
said highly advanced hospital side client is capable of receiving said medical information within the extent designated by the output extent from said data security server after being authenticated, and transmitting medical advice information; and
wherein said data security server is capable of storing and transmitting the medical advice information returned from said authenticated highly advanced hospital side client to said dental clinic side terminal which require it.

2. The dental treatment support system of claim 1, wherein said medical advice information includes medical advice from a doctor on the periodontitis.

3. An X-ray sensor for capturing the partially enlarged X-ray image of claim 1, said sensor comprising:
an X-ray light conversion member having a size capable of being put in a mouth cavity and converting the incident X-ray flux into visible light;
a CCD operable to detect both the intensity of the converted light and corresponding re-emitting position;
a non-volatile memory for receiving the both data output from said CCD and storing the intensity of the light and the corresponding re-emitting position in pairs; and
a wireless communication means operable to work responding to a wireless communication event and capable of outputting the original image stored in the non-volatile memory.
